(19) United States
(12) Patent Application Publication
(10) Pub. No.: US 2024/0167395 A1
(43) Pub. Date: May 23, 2024

(54) RUBBING POSITION IDENTIFICATION DEVICE AND RUBBING POSITION IDENTIFICATION METHOD FOR ROTATING MACHINE

(71) Applicant: MITSUBISHI HEAVY INDUSTRIES, LTD., Tokyo (JP)

(72) Inventors: Satoshi Kumagai, Tokyo (JP); Ryo Kawabata, Tokyo (JP); Shuichi Ishizawa, Tokyo (JP); Masahiko Yamashita, Yokohama-shi, Kanagawa (JP); Yoshinori Tanaka, Yokohama-shi, Kanagawa (JP)

(73) Assignee: MITSUBISHI HEAVY INDUSTRIES, LTD., Tokyo (JP)

(21) Appl. No.: 18/281,879

(22) PCT Filed: Mar. 23, 2022
(86) PCT No.: PCT/JP2022/013394

§ 371 Date: Sep. 13, 2023

(30) Foreign Application Priority Data
Mar. 26, 2021 (JP) 2021-054045

(51) Int. Cl. F01D 25/04; F01D 25/16

(52) U.S. Cl. CPC F01D 25/04; F01D 25/162; F05D 2220/31; F05D 2240/52; F05D 2270/333; F05D 2270/334

(57) ABSTRACT

A rotating machine includes a rotating part rotatably supported by a bearing disposed between a first stationary part and a second stationary part. A rubbing position identification device determines, when rubbing occurs on the rotating machine, whether the occurrence position of the rubbing is a first unit including the first stationary part or a second unit including the second stationary part, based on an AE signal detected by a pair of first AE sensors attached to the first stationary part and the second stationary part, respectively.

### TECHNICAL FIELD

The present disclosure relates to a rubbing position identification device and a rubbing position identification method for a rotating machine.

The present application claims priority based on Japanese Patent Application No. 2021-054045 filed on Mar. 26, 2021, the entire content of which is incorporated herein by reference.

### BACKGROUND ART

In a rotating machine including a rotating part that can rotate relative to a stationary part, rubbing (contact) can occur due to a reduction in the clearance between the stationary part and the rotating part. For example, in a steam turbine that uses steam as a working fluid, rubbing can occur between seal fins on the stationary part and a rotor, which is the rotating part, due to thermal deformation of the stationary part such as an outer casing and an inner casing during operation. In recent years, the clearance tends to be reduced to improve the performance of rotating machines, which increases the risk of rubbing. Since the occurrence of such rubbing causes shaft vibration of rotating machines and performance reduction due to seal deterioration, there is a need for a technique to detect the occurrence of rubbing at an early stage and provide feedback to the operation.

In response to such a need, for example, Patent Document 1 discloses a technique to detect rubbing using AE (Acoustic Emission) sensors capable of detecting AE signals. In Patent Document 1, AE sensors are installed in each of the bearings that support the rotating part on both sides in the rotating machine, and rubbing is detected based on AE signals detected by each AE sensor.

### CITATION LIST

### Patent Literature

Patent Document 1: JP3121365B

### SUMMARY

### Problems to be Solved

In Patent Document 1, the presence or absence of rubbing is determined based on AE signals detected by the AE sensors installed in the bearings that support the rotating part on both sides, but the position where rubbing occurs is not identified. Therefore, when rubbing is detected in Patent Document 1, measures must be considered for the entire rotating machine in order to eliminate or mitigate the rubbing. On the other hand, if the position where rubbing occurs can be identified, the target can be narrowed down to a specific area of the rotating machine, improving the efficiency.

When the rotating machine has a plurality of bearings supporting the rotating part, it is conceivable to install an AE sensor in each bearing and narrow down the position where rubbing occurs based on the position of the AE sensor that detects the rubbing, following the method described in Patent Document 1. However, if, for example, the rotating part is composed of multiple different members connected to each other in the axial direction, AE signals from the position where rubbing occurs may be blocked at the connection, and the AE sensor at the appropriate position may not detect the rubbing. Also, in a rotating machine operated by a working fluid, noise due to the working fluid may be included in AE signals, and the AE sensor at the appropriate position may not detect the rubbing. Also, if AE signals from the position where rubbing occurs are small, the AE sensor at the appropriate position may not detect the rubbing. Therefore, it is difficult to accurately identify the position where rubbing occurs with the technique described in Patent Document 1.

At least one embodiment of the present disclosure was made in view of the above circumstances, and an object thereof is to provide a rubbing position identification device and a rubbing position identification method for a rotating machine whereby it is possible to accurately identify the position where rubbing occurs, based on an AE signal detected by AE sensors.

### Solution to the Problems

In order to solve the above-described problems, a rubbing position identification device for a rotating machine according to at least one embodiment of the present disclosure is a rubbing position identification device for a rotating machine that includes a rotating part rotatably supported by a bearing disposed between a first stationary part and a second stationary part which are arranged along the axial direction, and includes: a pair of first AE sensors attached to the first stationary part and the second stationary part, respectively; and a rubbing occurrence position determination part for determining, when rubbing occurs on the rotating machine, whether the occurrence position of the rubbing is a first unit including the first stationary part or a second unit including the second stationary part, based on an AE signal detected by the pair of first AE sensors.

In order to solve the above-described problems, a rubbing position identification method for a rotating machine according to at least one embodiment of the present disclosure is a rubbing position identification method for a rotating machine that includes a rotating part rotatably supported by a bearing disposed between a first stationary part and a second stationary part which are arranged along the axial direction, and includes: a step of detecting an AE signal by a pair of first AE sensors attached to the first stationary part and the second stationary part, respectively; and a step of determining, when rubbing occurs on the rotating machine, whether the occurrence position of the rubbing is a first unit including the first stationary part or a second unit including the second stationary part, based on the AE signal.

### Advantageous Effects

At least one embodiment of the present disclosure provides a rubbing position identification device and a rubbing position identification method for a rotating machine whereby it is possible to accurately identify the position where rubbing occurs, based on an AE signal detected by AE sensors.

### BRIEF DESCRIPTION OF DRAWINGS

FIG. 1 is a cross-sectional structure diagram of a rotating machine according to an embodiment.

FIG. 2 is a flowchart showing a rubbing position identification method performed by a rubbing position identification device of FIG. 1.

FIG. 3 is a cross-sectional structure diagram of a rotating machine according to another embodiment.

FIG. 4 is a flowchart showing a rubbing position identification method performed by a rubbing position identification device of FIG. 4.

FIG. 5 is a cross-sectional structure diagram of a rotating machine according to another embodiment.

FIG. 6 is a flowchart showing a rubbing position identification method performed by a rubbing position identification device of FIG. 5.

### DETAILED DESCRIPTION

Embodiments of the present disclosure will be described below with reference to the accompanying drawings. It is intended, however, that unless particularly identified, dimensions, materials, shapes, relative positions, and the like of components described in the embodiments shall be interpreted as illustrative only and not intended to limit the scope of the present disclosure.

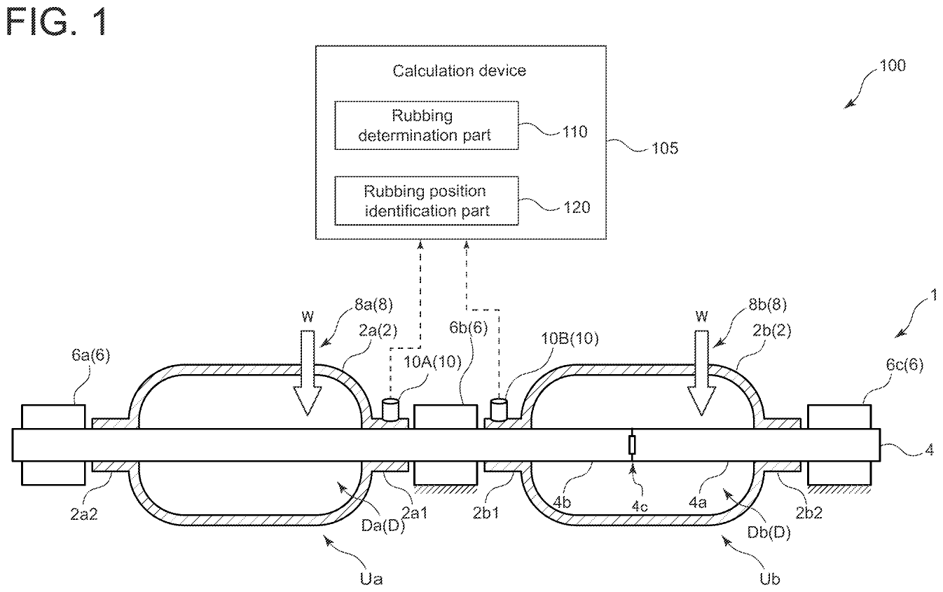

FIG. 1 is a cross-sectional structure diagram of a rotating machine 1 according to an embodiment. The rotating machine 1 has a stationary part 2 and a rotating part 4 that can rotate relative to the stationary part 2. The stationary part 2 is a casing of the rotating machine 1 and is stationary to the outside. The rotating part 4 is rotatably supported by the stationary part 2 via bearings 6 and can be driven by any power.

A clearance D is provided between the stationary part 2 and the rotating part 4 (more precisely, a clearance D is mainly formed between the innermost portion of the stator blade of the stationary part 2 and the outermost portion (tip) of the rotor blade of the rotating part 4, but it may also span between the stationary body to which the stator blade is attached and the rotating body to which the rotor blade is attached). The rotating part 4 is driven by introducing a working fluid W from the outside into the clearance D. The working fluid W that has driven the rotating part 4 is discharged to the outside. During operation of the rotating machine 1, at least one of the stationary part 2 or the rotating part 4 may be deformed by heat or other factors, which reduces the clearance D and causes rubbing. Such rubbing can be detected based on AE signals detected by AE sensors described below.

The rotating machine 1 includes a plurality of units U arranged along the axial direction (extension direction) of the rotating part 4. In this embodiment, the rotating machine 1 has a first unit Ua and a second unit Ub as the plurality of units U. The number of units included in the rotating machine 1 may be any number.

The first unit Ua and the second unit Ub share the rotating part 4, and have independent stationary parts 2 (first stationary part 2a and second stationary part 2b). That is, the first unit Ua is composed of the first stationary part 2a and the rotating part 4, and the second unit Ub is composed of the second stationary part 2b and the rotating part 4.

The rotating part 4 is a rotor that can be rotated by any power, and is powered by the working fluid W in this embodiment. In this embodiment, the rotating part 4 is formed by connecting a plurality of axially divided members (first member 4a and second member 4b) to each other at a joint portion 4c. The plurality of members may be made of different materials. In this case, AE signals from the position where rubbing occurs are likely to be blocked by the joint portion 4c, but the position where rubbing occurs can be suitably identified by detecting AE signals with each AE sensor 10 attached to the rotating machine 1, as described below.

The rotating machine 1 may use steam as the working fluid W, for example, and each unit U may be configured as a steam turbine. In this case, the flow path for the working fluid W may be independent in each unit U, or may be configured such that the units U are connected in series or in parallel. For example, when the flow paths for the working fluid W of the units U are connected in series, the first unit Ua may be a high-pressure turbine, and the second unit Ub may be a high-pressure turbine that can be driven by steam from the high-pressure turbine.

Each unit U has an inlet portion 8 for introducing the working fluid W from the outside into the clearance D, and an outlet portion (not shown) for discharging the working fluid W that has finished the work in the clearance D to the outside. Specifically, the first unit Ua has a first inlet portion 8a for introducing the working fluid W into the first clearance Da, and the second unit Ub has a second inlet portion 8b for introducing the working fluid W into the second clearance Db. In the vicinity of the inlet portion 8, noise due to the working fluid W may be generated, which may block AE signals from the position where rubbing occurs, but the position where rubbing occurs can be suitably identified by detecting AE signals with each AE sensor 10 attached to the rotating machine 1, as described below.

The rotating machine 1 has at least one bearing 6 (radial bearing) for supporting the rotating part 4. In this embodiment, the bearings 6 include bearings 6a, 6b and 6c. The bearing 6a is disposed at one end of the rotating part 4, the bearing 6b is disposed in an intermediate position of the rotating part 4 (specifically, between the first stationary part 2a constituting the first unit Ua and the second stationary part 2b constituting the second unit Ub), and the bearing 6c is provided at the other end of the rotating part 4 (on the side opposite to the bearing 6a). The rotating part 4 is rotatably supported by the plurality of bearings 6.

The rubbing position identification device 100 is a device for identifying, when it is determined that there is rubbing based on AE (Acoustic Emission; high frequency output) signals detected by AE sensors 10, the occurrence position of the rubbing in the rotating machine 1 having the above configuration. The rotating machine 1 generates AE waves when, for example, a seal attached to the stationary part 2 that has undergone thermal deformation rubs against the rotating part 4. For example, AE waves generated at the position where rubbing occurs propagate through the stationary part 2 and the rotating part 4 as elastic waves, and are detected as AE signals by each AE sensor 10 installed in the rotating machine 1. AE waves generally have frequencies in the sonic range of several 10 kHz to several MHz.

The rubbing position identification device 100 is equipped with a calculation device 105 for calculation to identify the rubbing occurrence position when rubbing occurs, based on AE signals detected by the AE sensor 10 installed in the rotating machine 1. The calculation device 105 includes, for example, a central processing unit (CPU), a random access memory (RAM), a read only memory (ROM), a computer-readable storage medium, and the like. Then, a series of processes for realizing various functions is stored in the storage medium or the like in the form of a program, as an example. The CPU reads the program out to the RAM or the like and executes processing/calculation of information, thereby realizing the various functions. The program may be installed in the ROM or another storage medium in advance, or may be stored in the computer-readable storage medium and provided, or may be distributed through wired or wireless communication means, for example. The computer-readable storage medium may be a magnetic disk, a magneto-optical disk, a CD-ROM, a DVD-ROM, or a semiconductor memory.

The calculation device 105 includes a rubbing determination part 110 for acquiring AE signals detected by the AE sensor 10 and determining the presence or absence of rubbing based on the AE signals, and a rubbing position identification part 120 for identifying, when it is determined that there is rubbing, the occurrence position of the rubbing. The method for determining the presence or absence of rubbing in the rubbing determination part 110 follows known examples and will not be described in detail.

The rubbing position identification device 100 in this embodiment includes, as the AE sensor 10, a pair of first AE sensors 10A, 10B attached to the first stationary part 2a and the second stationary part 2b, respectively. As described above, the bearing 6b is disposed between the first stationary part 2a and the second stationary part 2b, and the pair of first AE sensors 10A, 10B is attached to first end portions 2a1, 2b1 of the first stationary part 2a and the second stationary part 2b closer to the bearing 6b. When rubbing occurs on the rotating machine 1, AE waves propagating from the occurrence position of the rubbing through the first stationary part 2a and the second stationary part 2b are suitably detected by the pair of AE sensors 10A, 10B.

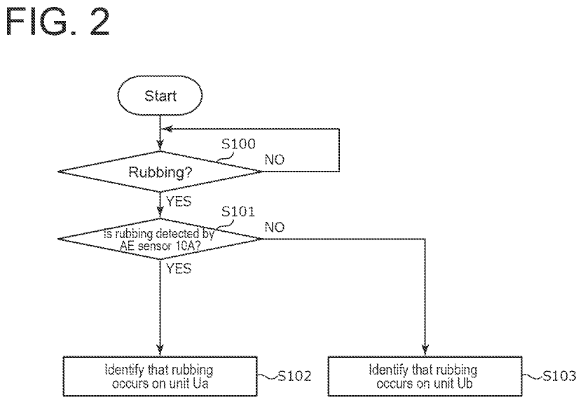

FIG. 2 is a flowchart showing a rubbing position identification method performed by the rubbing position identification device 100 of FIG. 1. First, the rubbing determination part 110 determines whether there is rubbing (step S100). The rubbing determination in step S100 is made, for example, based on AE signals detected by at least one of the pair of AE sensors 10A, 10B. If it is determined that there is no rubbing with any of the AE signals detected by the AE sensors 10A, 10B (step S100: NO), the rubbing determination part 110 repeats step S100 to monitor rubbing. If it is determined that there is rubbing with at least one of the AE signals detected by the AE sensors 10A, 10B (step S100: YES), the process proceeds to the next step.

This embodiment describes the case where the rubbing determination is made based on AE signals detected by the AE sensors in step S100 as an example, but the rubbing determination may be made based on shaft vibration signals detected by a shaft vibration sensor instead of the AE signals, or the rubbing determination may be made based on both the AE signals and the shaft vibration signals.

If the rubbing determination part 110 determines that there is rubbing (step S100: YES), the rubbing position identification part 120 determines which of the pair of first AE sensors 10A, 10B detected the AE signal corresponding to the rubbing occurrence. Specifically, the rubbing position identification part 120 determines whether the AE signal corresponding to the rubbing occurrence is detected by one first AE sensor 10A (step S101). As a result, if the AE signal corresponding to the rubbing occurrence is detected by the first AE sensor 10A (step S101: YES), the rubbing position identification part 120 identifies the first unit Ua as the occurrence position of the rubbing (step S102). On the other hand, if the AE signal corresponding to the rubbing occurrence is not detected by the first AE sensor 10A (step S101: NO), the rubbing position identification part 120 identifies the second unit Ub as the occurrence position of the rubbing (step S103).

Thus, when the AE signal corresponding to rubbing is detected by either one of the pair of first AE sensors 10A, 10B, the rubbing position identification part 120 can identify the unit to which the first AE sensor that detects the AE signal is attached as the occurrence position of the rubbing.

Such identification of the occurrence position of rubbing is particularly advantageous, for example, in the following case. One possible configuration for identifying the occurrence position of rubbing is to place AE sensors on the bearings 6a, 6b, and 6c, respectively. However, in this configuration, as shown in FIG. 1, if the joint portion 4c of the rotating part 4 is disposed between the bearings 6b and 6c (or if the joint portion 4c is disposed between the bearings 6a and 6b, similarly), the rubbing waveform may be blocked by the joint portion 4c. For example, when rubbing occurs on the first unit Ua and there is the joint portion 4c between the bearings 6a and 6b, the AE signal from the occurrence position of the rubbing may be blocked by the joint portion 4c and cannot be detected by the AE sensor installed in the bearing 6a, making it difficult to identify the occurrence position of the rubbing. Further, when rubbing occurs on the second unit Ub and, as shown in FIG. 1, there is the joint portion 4c between the bearings 6b and 6c, the AE signal from the occurrence position of the rubbing may be blocked by the joint portion 4c and cannot be detected by the AE sensor installed in the bearing 6c, making it difficult to identify the occurrence position of the rubbing.

In contrast, in the embodiment shown in FIGS. 1 and 2, since the first AE sensors 10A, 10B are attached to the first stationary part 2a and the second stationary part 2b, respectively, AE signals propagating through the first stationary part 2a and the second stationary part 2b from the occurrence position of rubbing can be detected by the first AE sensors 10A, 10B. Therefore, regardless of the position of the joint portion 4c, AE signals can be accurately detected by the first AE sensors 10A, 10B, and the occurrence position of rubbing can be identified based on the AE signals.

Further, as shown in FIG. 1, the first unit Ua and the second unit Ub have a first inlet portion 8a and a second inlet portion 8b for introducing the working fluid W between the bearings 6a and 6b and between the bearings 6b and 6c, respectively. Since noise due to the working fluid is generated in the first inlet portion 8a and the second inlet portion 8b, the configuration in which AE sensors are placed on the bearings 6a, 6b, and 6c may not provide sufficient identification accuracy because the AE signals detected by each AE sensor may contain noise depending on the occurrence position of rubbing.

In contrast, in the embodiment shown in FIGS. 1 and 2, since the first AE sensors 10A, 10B are attached to the first stationary part 2a and the second stationary part 2b, respectively, AE signals propagating through the first stationary part 2a and the second stationary part 2b from the occurrence position of rubbing can be detected by the first AE sensors 10A, 10B. Therefore, the system is less susceptible to noise due to the working fluid W in the first inlet portion 8a and the second inlet portion 8b, so that AE signals can be accurately detected by the first AE sensors 10A, 10B, and the occurrence position of rubbing can be identified based on the AE signals.

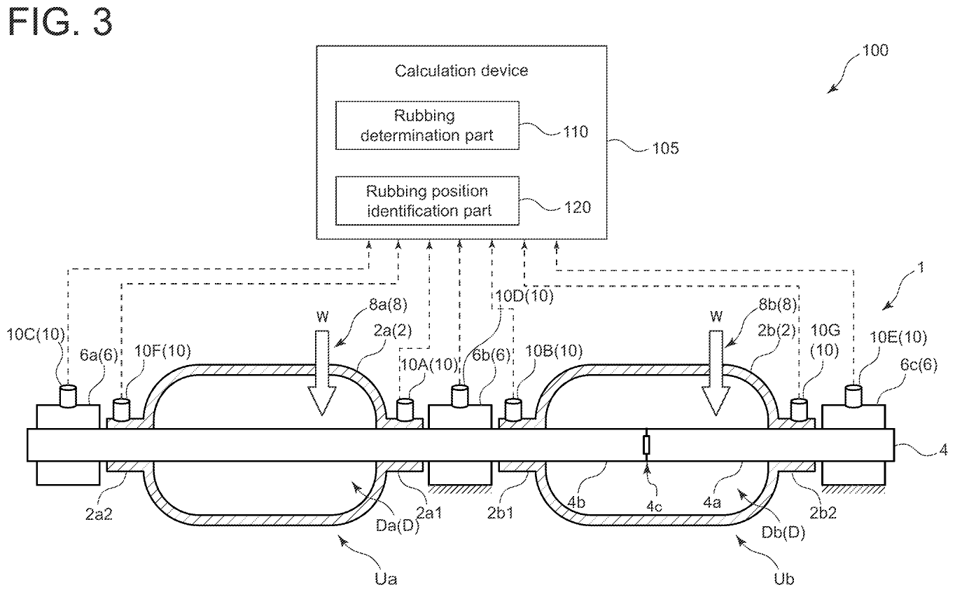

FIG. 3 is a cross-sectional structure diagram of the rotating machine 1 according to another embodiment. In the following description, configurations corresponding to those in the above-described embodiment are associated with the same reference numerals, and not described again unless otherwise required.

In this embodiment, the rubbing position identification device 100 includes, as the AE sensor 10, second AE sensors 10C, 10D, 10E attached to the bearings 6a, 6b, 6c, respectively. The second AE sensors 10C, 10D, 10E may be attached to the respective bearing housings of the bearings 6a, 6b, 6c to suitably detect AE waves propagating from the occurrence position of rubbing to the bearings 6a, 6b, 6c through the rotating part 4.

If the bearing housings of the bearings 6a, 6b, 6c have an upper/lower split structure, the second sensors 10C, 10D, 10E may be attached to the lower split bodies of the bearing housings. Since rubbing tends to occur on the lower side of the rotating machine 1, by attaching the second sensors 10C, 10D, 10E to the lower split bodies of the bearing housings, AE waves corresponding to the rubbing occurrence can be detected appropriately.

While the first AE sensors 10A, 10B attached to the stationary parts 2a, 2b detect AE waves propagating from the occurrence position of rubbing through the stationary parts 2a, 2b, the second AE sensors 10C, 10D, 10E can detect AE waves propagating in different paths than the first AE sensors 10A, 10B (e.g., AE waves propagating through the rotating part 4). By providing the second AE sensors 10C, 10D, 10E in addition to the first AE sensors 10A, 10B, the rubbing position identification device 100 can more accurately determine the presence or absence of rubbing and identify the occurrence position of rubbing, based on AE waves propagating in different paths.

The rubbing position identification device 100 further includes, as the AE sensor 10, third AE sensors 10F, 10G. The third AE sensors 10F, 10G are attached to the first stationary part 2a and the second stationary part 2b, respectively, as with the first AE sensors 10A, 10B described above. The third AE sensors 10F, 10G are attached to second end portions 2a2, 2b2 of the first stationary part 2a and the second stationary part 2b opposite to the first end portions 2a1, 2ba (closer to the bearing 6b) to which the first AE sensors 10A, 10B are attached, respectively.

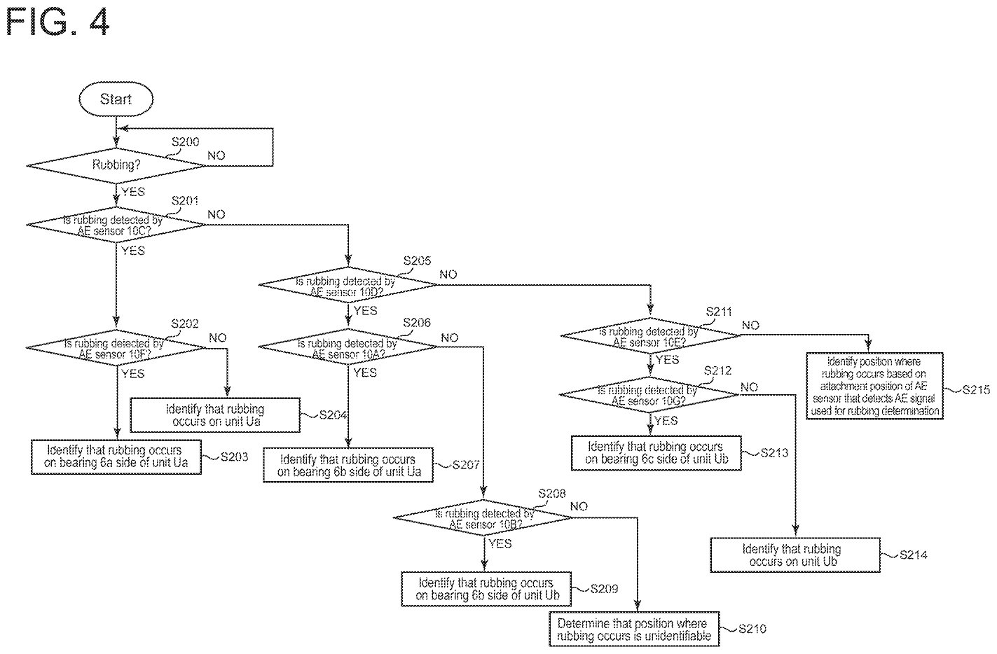

FIG. 4 is a flowchart showing a rubbing position identification method performed by the rubbing position identification device 100 of FIG. 3. First, the rubbing determination part 110 determines whether there is rubbing (step S200). The rubbing determination in step S200 is made, for example, by whether an AE signal corresponding to the rubbing occurrence is detected by any of the first AE sensors 10A, 10B, the second AE sensors 10C, 10D, 10E, and the third AE sensors 10F, 10G.

If the rubbing determination part 110 determines that there is rubbing (step S200: YES), the rubbing position identification part 120 determines which of the second AE sensors 10C, 10D, 10E detected the AE signal corresponding to the rubbing occurrence. In other words, to identify the occurrence position of the rubbing, the first step is to determine which of the second AE sensors 10C, 10D, 10E attached to the bearings 6a, 6b, 6c, respectively, detected AE waves from the occurrence position of the rubbing.

Specifically, the rubbing position identification part 120 determines whether the AE signal corresponding to the rubbing occurrence is detected by the second AE sensor 10C attached to the bearing 6a (step S201). As a result, if the AE signal corresponding to the rubbing occurrence is detected by the second AE sensor 10C (step S201: YES), the rubbing position identification part 120 determines whether the AE signal corresponding to the rubbing occurrence is detected by the third AE sensor 10F attached to the first stationary part 2a (step S202). As a result, if the AE signal corresponding to the rubbing occurrence is detected by the third AE sensor 10F (step S202: YES), the rubbing position identification part 120 identifies the bearing 6a side of the first unit Ua as the occurrence position of the rubbing (step S203). On the other hand, if the AE signal corresponding to the rubbing occurrence is not detected by the third AE sensor 10F (step S202: NO), the rubbing position identification part 120 identifies somewhere in the first unit Ua as the occurrence position of the rubbing (step S204).

Further, the rubbing position identification part 120 determines whether the AE signal corresponding to the rubbing occurrence is detected by the second AE sensor 10D attached to the bearing 6b (step S205). As a result, if the AE signal corresponding to the rubbing occurrence is detected by the second AE sensor 10D (step S205: YES), the rubbing position identification part 120 determines whether the AE signal corresponding to the rubbing occurrence is detected by the first AE sensor 10A attached to the first stationary part 2a (step S206). As a result, if the AE signal corresponding to the rubbing occurrence is detected by the first AE sensor 10A (step S206: YES), the rubbing position identification part 120 identifies the bearing 6b side of the first unit Ua as the occurrence position of the rubbing (step S207). On the other hand, if the AE signal corresponding to the rubbing occurrence is not detected by the first AE sensor 10A (step S206: NO), the rubbing position identification part 120 determines whether the AE signal corresponding to the rubbing occurrence is detected by the first AE sensor 10B attached to the second stationary part 2b (step S208). As a result, if the AE signal corresponding to the rubbing occurrence is detected by the first AE sensor 10B (step S208: YES), the rubbing position identification part 120 identifies the bearing 6b side of the second unit Ub as the occurrence position of the rubbing (step S209). On the other hand, if the AE signal corresponding to the rubbing occurrence is not detected even by the first AE sensor 10B (step S208: NO), the rubbing position identification part 120 determines that the occurrence position of the rubbing is unidentifiable (step S210).

Further, the rubbing position identification part 120 determines whether the AE signal corresponding to the rubbing occurrence is detected by the second AE sensor 10E attached to the third bearing 6c (step S211). As a result, if the AE signal corresponding to the rubbing occurrence is detected by the second AE sensor 10E (step S211: YES), the rubbing position identification part 120 determines whether the AE signal corresponding to the rubbing occurrence is detected by the third AE sensor 10G attached to the second stationary part 2b (step S212). As a result, if the AE signal corresponding to the rubbing occurrence is detected by the third AE sensor 10G (step S212: YES), the rubbing position identification part 120 identifies the third bearing 6c side of the second unit Ub as the occurrence position of the rubbing (step S213). On the other hand, if the AE signal corresponding to the rubbing occurrence is not detected by the third AE sensor 10G (step S212: NO), the rubbing position identification part 120 identifies somewhere in the second unit Ub as the occurrence position of the rubbing (step S214).

If the AE signal corresponding to the rubbing occurrence is not detected by the second AE sensor 10E (step S211: NO), the rubbing position identification part 120 identifies the occurrence position of the rubbing, based on the installation position of the AE sensor that detected the AE signal with which it is determined that there is rubbing in step S200 (step S215).

Thus, in this embodiment, the occurrence position of rubbing in the rotating machine 1 can be identified in more detail, based on AE signals detected by the second AE sensors 10C, 10D, 10E and the third AE sensors 10F, 10G, in addition to the first AE sensors 10A, 10B.

Such identification of the occurrence position of rubbing is particularly advantageous, for example, in the following case. One possible configuration for identifying the occurrence position of rubbing is to place only second AE sensors 10C, 10D, 10E on the bearings 6a, 6b, and 6c. However, in this configuration, as shown in FIG. 3, if the joint portion 4c of the rotating part 4 is disposed between the bearings 6b and 6c (or if the joint portion 4c is disposed between the bearings 6a and 6b, similarly), the rubbing waveform may be blocked by the joint portion 4c. For example, when rubbing occurs on the first unit Ua and there is the joint portion 4c between the bearings 6a and 6b, the AE signal from the occurrence position of the rubbing may be blocked by the joint portion 4c and cannot be detected by the second AE sensor 10C installed in the bearing 6a, making it difficult to identify the occurrence position of the rubbing. Further, when rubbing occurs on the second unit Ub and, as shown in FIG. 3, there is the joint portion 4c between the bearings 6b and 6c, the AE signal from the occurrence position of the rubbing may be blocked by the joint portion 4c and cannot be detected by the second AE sensor 10E installed in the bearing 6c, making it difficult to identify the occurrence position of the rubbing.

In contrast, in the embodiment shown in FIGS. 3 and 4, since the first AE sensors 10A, 10B are attached to the first stationary part 2a and the second stationary part 2b, respectively, and the third AE sensors 10F, 10G are attached to the first stationary part 2a and the second stationary part 2b, respectively, the AE signals propagating through the first stationary part 2a and the second stationary part 2b from the occurrence position of rubbing can be detected by the first AE sensors 10A, 10B and the third AE sensors 10F, 10G. Therefore, regardless of the position of the joint portion 4c, AE signals can be accurately detected by the first AE sensors 10A, 10B and the third AE sensors 10F, 10G, and the occurrence position of rubbing can be identified based on the AE signals.

Further, as shown in FIG. 1, the first unit Ua and the second unit Ub have a first inlet portion 8a and a second inlet portion 8b for introducing the working fluid W between the bearings 6a and 6b and between the bearings 6b and 6c, respectively. Since noise due to the working fluid is generated in the first inlet portion 8a and the second inlet portion 8b, the configuration in which second AE sensors 10C, 10D, 10E are placed on the bearings 6a, 6b, and 6c may not provide sufficient identification accuracy because the AE signals detected by each AE sensor may contain noise depending on the occurrence position of rubbing.

In contrast, in the embodiment shown in FIGS. 3 and 4, since the first AE sensors 10A, 10B are attached to the first stationary part 2a and the second stationary part 2b, respectively, and the third AE sensors 10F, 10G are attached to the first stationary part 2a and the second stationary part 2b, respectively, the AE signals propagating through the first stationary part 2a and the second stationary part 2b from the occurrence position of rubbing can be detected by the first AE sensors 10A, 10B and the third AE sensors 10F, 10G. Therefore, the system is less susceptible to noise due to the working fluid W in the first inlet portion 8a and the second inlet portion 8b, so that AE signals can be accurately detected by the first AE sensors 10A, 10B and the third AE sensors 10F, 10G, and the occurrence position of rubbing can be identified based on the AE signals.

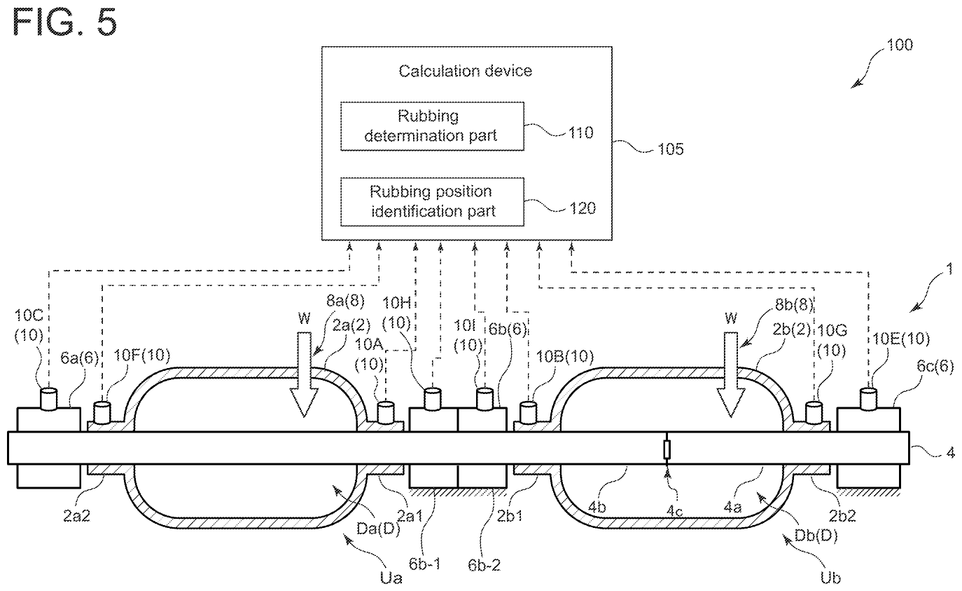

FIG. 5 is a cross-sectional structure diagram of the rotating machine 1 according to another embodiment. In the following description, configurations corresponding to those in the above-described embodiment are associated with the same reference numerals, and not described again unless otherwise required.

In this embodiment, the bearing 6b disposed between the first stationary part 2a and the second stationary part 2b of the rotating machine 1 includes a first bearing 6b-1 and a second bearing 6b-2 arranged along the axial direction of the rotating part 4. The first bearing 6b-1 and the second bearing 6b-2 are radial bearings that rotatably support the rotating part 4 and are housed in a common bearing box. A fourth AE sensor 10H and a fifth AE sensor 10I are attached to the bearing box instead of the second AE sensor D in the embodiment shown in FIG. 3. The fourth AE sensor 10H and the fifth AE sensor 10I are arranged at different positions in the bearing box along the axial direction with a distance ΔL.

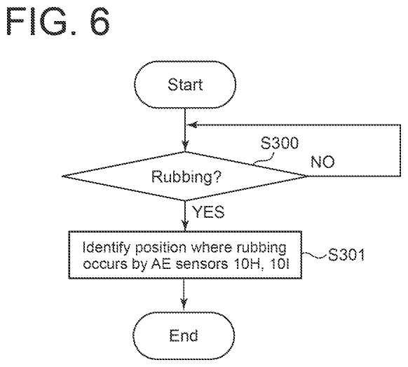

FIG. 6 is a flowchart showing a rubbing position identification method performed by the rubbing position identification device 100 of FIG. 5. First, the rubbing determination part 110 determines whether there is rubbing (step S300). The rubbing determination in step S200 is made, for example, by whether an AE signal corresponding to the rubbing occurrence is detected by any of the first AE sensors 10A, 10B, the third AE sensors 10F, 10G, the fourth AE sensor 10H, and the fifth AE sensor 10I.

Then, the rubbing position identification part 120 identifies the occurrence position of the rubbing, based on a time difference or a phase difference between AE signals detected by the fourth AE sensor 10H and the fifth AE sensor 10I (step S301). Since the fourth AE sensor 10H and the fifth AE sensor 10I are arranged at a distance ΔL from each other as described above, there will be a time difference or a phase difference in the timing of detection of AE waves from the rubbing. Therefore, in step S302, by evaluating such a time difference or a phase difference, whether the occurrence position of the rubbing is in the first unit Ua or the second unit Ub can be identified. For example, if AE waves are detected by the fourth AE sensor 10H at an earlier timing than the fifth AE sensor 10I, the occurrence position of the rubbing is identified as being in the first unit Ua, which is closer to the fourth AE sensor 10H. For example, if AE waves are detected by the fifth AE sensor 10I at an earlier timing than the fourth AE sensor 10H, the occurrence position of the rubbing is identified as being in the second unit Ub, which is closer to the fifth AE sensor 10I.

The rubbing position identification part 120 may further identify the occurrence position of the rubbing, based on AE signals detected by the first AE sensors 10A, 10B, the third AE sensors 10F, 10G, the fourth AE sensor 10H, and the fifth AE sensor 10I, as in the above-described embodiment, and check the identification result against the identification result of step S301. This check result can be used as appropriate by recording it in a predetermined recording device, for example.

Thus, in this embodiment, as in the above-described embodiment, the occurrence position of rubbing can be identified with better accuracy by checking the identification result of the occurrence position of rubbing based on AE signals detected by each AE sensor 10 against the identification result based on the time difference or phase difference between AE signals detected by the fourth AE sensor 10H and the fifth AE sensor 10I.

Such identification of the occurrence position of rubbing is particularly advantageous, for example, in the following case. One possible configuration for identifying the occurrence position of rubbing is to place only AE sensors 10C, 10H, 10I, 10E on the bearings 6a, 6b-1, 6b-2, and 6c. However, in this configuration, as shown in FIG. 5, if the joint portion 4c of the rotating part 4 is disposed between the bearings 6b and 6c (or if the joint portion 4c is disposed between the bearings 6a and 6b, similarly), the rubbing waveform may be blocked by the joint portion 4c. For example, when rubbing occurs on the first unit Ua and there is the joint portion 4c between the bearings 6a and 6b, the AE signal from the occurrence position of the rubbing may be blocked by the joint portion 4c and cannot be detected by the second AE sensor 10C installed in the bearing 6a, making it difficult to identify the occurrence position of the rubbing. Further, when rubbing occurs on the second unit Ub and, as shown in FIG. 5, there is the joint portion 4c between the bearings 6b and 6c, the AE signal from the occurrence position of the rubbing may be blocked by the joint portion 4c and cannot be detected by the second AE sensor 10E installed in the bearing 6c, making it difficult to identify the occurrence position of the rubbing.

In contrast, in the embodiment shown in FIGS. 5 and 6, since the first AE sensors 10A, 10B are attached to the first stationary part 2a and the second stationary part 2b, respectively, and the third AE sensors 10F, 10G are attached to the first stationary part 2a and the second stationary part 2b, respectively, the AE signals propagating through the first stationary part 2a and the second stationary part 2b from the occurrence position of rubbing can be detected by the first AE sensors 10A, 10B and the third AE sensors 10F, 10G. Therefore, regardless of the position of the joint portion 4c, AE signals can be accurately detected by the first AE sensors 10A, 10B and the third AE sensors 10F, 10G, and the occurrence position of rubbing can be identified based on the AE signals.

Further, as shown in FIG. 1, the first unit Ua and the second unit Ub have a first inlet portion 8a and a second inlet portion 8b for introducing the working fluid W between the bearings 6a and 6b and between the bearings 6b and 6c, respectively. Since noise due to the working fluid is generated in the first inlet portion 8a and the second inlet portion 8b, the configuration in which AE sensors 10C, 10H, 10I, 10E are placed on the bearings 6a, 6b-1, 6b-2, and 6c may not provide sufficient identification accuracy because the AE signals detected by each AE sensor may contain noise depending on the occurrence position of rubbing.

In contrast, in the embodiment shown in FIGS. 5 and 6, since the first AE sensors 10A, 10B are attached to the first stationary part 2a and the second stationary part 2b, respectively, and the third AE sensors 10F, 10G are attached to the first stationary part 2a and the second stationary part 2b, respectively, the AE signals propagating through the first stationary part 2a and the second stationary part 2b from the occurrence position of rubbing can be detected by the first AE sensors 10A, 10B and the third AE sensors 10F, 10G. Therefore, the system is less susceptible to noise due to the working fluid W in the first inlet portion 8a and the second inlet portion 8b, so that AE signals can be accurately detected by the first AE sensors 10A, 10B and the third AE sensors 10F, 10G, and the occurrence position of rubbing can be identified based on the AE signals.

In the above embodiments, the occurrence position of rubbing in the rotating machine 1 is identified. The identification results of the occurrence position of rubbing can be used for various measures to eliminate or mitigate the rubbing occurring on the rotating machine 1. For example, if the occurrence position of rubbing is identified to be in either the first unit Ua or the second unit Ub, the measures may be implemented for that unit instead of the entire rotating machine 1. As one such measure, the area containing the occurrence position of rubbing may be opened and inspected. By identifying the target unit, the burden required for the measure can be significantly reduced. As a result, the cost and construction period required for the measure can be effectively reduced. It is also possible to change the operation method to eliminate or mitigate the rubbing, but even in the case of such a measure, identifying the target unit can help to ensure effective implementation.

In addition, the components in the above-described embodiments may be appropriately replaced with known components without departing from the spirit of the present disclosure, or the above-described embodiments may be appropriately combined.

The contents described in the above embodiments would be understood as follows, for instance.

(1) A rubbing position identification device according to one aspect is a rubbing position identification device (e.g., the above-described rubbing position identification device 100) for a rotating machine (e.g., the above-described rotating machine 1) that includes a rotating part (e.g., the above-described rotating part 4) rotatably supported by a bearing (e.g., the above-described bearing 6b) disposed between a first stationary part (e.g., the above-described first stationary part 2a) and a second stationary part (e.g., the above-described second stationary part 2b) which are arranged along the axial direction, and includes: a pair of first AE sensors (e.g., the above-described first AE sensors 10A, 10B) attached to the first stationary part and the second stationary part, respectively; and a rubbing position identification part (e.g., the above-described rubbing position identification part 120) for determining, when rubbing occurs on the rotating machine, whether the occurrence position of the rubbing is a first unit (e.g., the above-described first unit Ua) including the first stationary part or a second unit (e.g., the above-described second unit Ub) including the second stationary part, based on an AE signal detected by the pair of first AE sensors.

According to the above aspect (1), the rotating machine has the rotating part that is rotatably supported by the bearing disposed between the first stationary part and the second stationary part which are arranged along the axial direction. The pair of first AE sensors is attached to the first stationary part and the second stationary part, respectively. When rubbing occurs on the rotating machine, the occurrence position of the rubbing, i.e., whether the rubbing occurs on the first unit including the first stationary part or the second unit including the second stationary part of the rotating machine, is identified based on an AE signal detected by the pair of first AE sensors.

(2) In another aspect, in the above aspect (1), the rubbing position identification part is configured to identify, when either one of the pair of first AE sensors detects the AE signal corresponding to the rubbing, a unit to which the first AE sensor that detects the AE signal is attached as the occurrence position of the rubbing.

According to the above aspect (2), the rubbing position identification part determines which of the pair of first AE sensors detects the AE signal corresponding to the rubbing. Then, it identifies the unit having the stationary part to which the first AE sensor that detects the AE signal corresponding to the rubbing is attached as the occurrence position of the rubbing, based on the determination result.

(3) In another aspect, in the above aspect (1) or (2), the device further includes: a second AE sensor (e.g., the above-described second AE sensors 10C, 10D, 10E) attached to the bearing; and a rubbing determination part (e.g., the above-described rubbing determination part 110) for determining the presence or absence of the rubbing, based on an AE signal detected by the second AE sensor.

According to the above aspect (3), the presence or absence of rubbing in the rotating machine is determined based on an AE signal detected by the second AE sensor attached to the bearing. If it is determined that there is rubbing in the rotating machine, as described above, the occurrence position of the rubbing can be identified based on the AE signal detected by the pair of first AE sensors.

(4) In another aspect, in any of the above aspects (1) to (3), the pair of first AE sensors is attached to first end portions (e.g., the above-described first end portions 2a1, 2b1) of the first stationary part and the second stationary part closer to the bearing.

According to the above aspect (4), since the pair of first AE sensors is attached to the end portions of the stationary parts closer to the bearing, AE signals generated by rubbing and propagating through the stationary parts can be suitably detected.

(5) In another aspect, in any one of the above aspects (1) to (4), the device further includes a pair of third AE sensors (e.g., the above-described third AE sensors 10F, 10G) attached to second end portions (e.g., the above-described second end portions 2a2, 2b2) of the first stationary part and the second stationary part opposite to the first end portions, respectively. The rubbing position identification part is configured to identify the occurrence position of the rubbing, based on AE signals detected by the pair of first AE sensors and the pair of third AE sensors.

According to the above aspect (5), the third AE sensors are attached to the second end portions opposite to the first end portions to which the first AE sensors are attached. As a result, by comparing the detection results of the first AE sensors and the third AE sensors, it is possible to identify whether the rubbing occurs on the first end side or the second end side of the stationary part.

(6) In another aspect, in any of the above aspects (1) to (5), the bearing includes a first bearing (e.g., the above-described first bearing 6b1) and a second bearing (e.g., the above-described second bearing 6b2) arranged adjacent to each other along the axial direction. The device further includes: a fourth AE sensor (e.g., the above-described fourth AE sensor 10H) attached to the first bearing; and a fifth AE sensor (e.g., the above-described fifth AE sensor 10I) attached to the second bearing. The rubbing position identification part is configured to identify the occurrence position of the rubbing, based on a time difference or a phase difference between AE signals detected by the fourth AE sensor and the fifth AE sensor.

According to the above aspect (6), the bearing disposed between the first unit and the second unit includes a first bearing and a second bearing. The fourth AE sensor and the fifth AE sensor are attached to the first bearing and the second bearing, respectively. The rubbing position identification part can identify the occurrence position of rubbing based on AE signals detected by the pair of first AE sensors as described above, but it can also identify the occurrence position based on a time difference or a phase difference between AE signals detected by the fourth AE sensor and the fifth AE sensor, and good identification accuracy can be obtained by comparing the two results.

(7) In another aspect, in any of the above aspects (1) to (6), the rotating part includes a plurality of members (e.g., the above-described first member 4a and second member 4b) connected to each other along the axial direction via a joint portion (e.g., the above-described joint portion 4c).

According to the above aspect (7), when the rotating part has the joint portion, AE signals from the occurrence position of rubbing are likely to be blocked by the joint portion, but by detecting AE signals with the pair of first AE sensors attached to the first stationary part and the second stationary part, respectively, as described above, it is possible to suitably identify whether the occurrence position of rubbing is in the first unit or the second unit.

(8) In another aspect, in any of the above aspects (1) to (7), the first unit and the second unit have inlet portions (e.g., the above-described inlet portions 8) for introducing a working fluid (e.g., the above-described working fluid W) into between the first stationary part and the rotating part and between the second stationary part and the rotating part, respectively.

According to the above aspect (8), when there is an inlet portion for the working fluid for driving the first unit and the second unit, noise due to the working fluid may be generated in the vicinity of the inlet portion, which may block AE signals from the occurrence position of rubbing, but by detecting AE signals with the pair of first AE sensors attached to the first stationary part and the second stationary part, respectively, as described above, it is possible to suitably identify whether the occurrence position of rubbing is in the first unit or the second unit.

(9) A rubbing position identification method according to one aspect is a rubbing position identification method for a rotating machine (e.g., the above-described rotating machine 1) that includes a rotating part (e.g., the above-described rotating part 4) rotatably supported by a bearing (e.g., the above-described) disposed between a first stationary part (e.g., the above-described first stationary part 2a) and a second stationary part (e.g., the above-described second stationary part 2b) arranged along the axial direction, and includes: a step of detecting an AE signal by a pair of first AE sensors (e.g., the above-described first AE sensors 10A, 10B) attached to the first stationary part and the second stationary part, respectively; and a step of determining, when rubbing occurs on the rotating machine, whether an occurrence position of the rubbing is a first unit (e.g., the above-described first unit Ua) including the first stationary part or a second unit (e.g., the above-described second unit Ub) including the second stationary part, based on the AE signal.

According to the above aspect (9), the rotating machine has the rotating part that is rotatably supported by the bearing disposed between the first stationary part and the second stationary part arranged along the axial direction. The pair of first AE sensors is attached to the first stationary part and the second stationary part, respectively. When rubbing occurs on the rotating machine, the occurrence position of the rubbing, i.e., whether the rubbing occurs on the first unit including the first stationary part or the second unit including the second stationary part of the rotating machine, is identified based on an AE signal detected by the pair of first AE sensors.

### REFERENCE SIGNS LIST

1 Rotating machine
2 Stationary part
2a First stationary part
2b Second stationary part
2a1, 2b1 First end portion
2a2, 2b2 Second end portion
4 Rotating part
4a First member
4b Second member
4c Joint portion
6 (6a, 6b, 6c) Bearing
6b1 First bearing
6b2 Second bearing
8 Inlet portion
8a First inlet portion
8b Second inlet portion
10 AE sensor
10A, 10B First sensor
10C, 10D, 10E Second sensor
10F, 10G Third sensor
10H Fourth sensor
10I Fifth sensor
100 Rubbing position identification device
105 Calculation device
110 Rubbing determination part
120 Rubbing position identification part
D Clearance
Da First clearance
Db Second clearance
U Unit
Ua First unit
Ub Second unit
W Working fluid

1. A rubbing position identification device for a rotating machine that includes a rotating part rotatably supported by a bearing disposed between a first stationary part and a second stationary part which are arranged along an axial direction, the rubbing position identification device comprising:
a pair of first AE sensors attached to the first stationary part and the second stationary part, respectively; and
a rubbing position identification part for determining, when rubbing occurs on the rotating machine, whether an occurrence position of the rubbing is a first unit including the first stationary part or a second unit including the second stationary part, based on an AE signal detected by the pair of first AE sensors.

2. The rubbing position identification device according to claim 1,
wherein the rubbing position identification part is configured to identify, when either one of the pair of first AE sensors detects the AE signal corresponding to the rubbing, a unit to which the first AE sensor that detects the AE signal is attached as the occurrence position of the rubbing.

3. The rubbing position identification device according to claim 1, further comprising:
a second AE sensor attached to the bearing; and
a rubbing determination part for determining the presence or absence of the rubbing, based on an AE signal detected by the second AE sensor.

4. The rubbing position identification device according to claim 1,
wherein the pair of first AE sensors is attached to first end portions of the first stationary part and the second stationary part closer to the bearing.

5. The rubbing position identification device according to claim 1, further comprising a pair of third AE sensors attached to second end portions of the first stationary part and the second stationary part opposite to the first end portions, respectively, and
wherein the rubbing position identification part is configured to identify the occurrence position of the rubbing, based on AE signals detected by the pair of first AE sensors and the pair of third AE sensors.

6. The rubbing position identification device according to claim 1,
wherein the bearing includes a first bearing and a second bearing arranged adjacent to each other along the axial direction,
wherein the rubbing position identification device further comprises:
a fourth AE sensor attached to the first bearing; and
a fifth AE sensor attached to the second bearing, and
wherein the rubbing position identification part is configured to identify the occurrence position of the rubbing, based on a time difference or a phase difference between AE signals detected by the fourth AE sensor and the fifth AE sensor.

7. The rubbing position identification device according to claim 1,
wherein the rotating part includes a plurality of members connected to each other along the axial direction via a joint portion.

8. The rubbing position identification device according to claim 1,
wherein the first unit and the second unit have inlet portions for introducing a working fluid into between the first stationary part and the rotating part and between the second stationary part and the rotating part, respectively.

9. A rubbing position identification method for a rotating machine that includes a rotating part rotatably supported by a bearing disposed between a first stationary part and a second stationary part which are arranged along an axial direction, the rubbing position identification method comprising:
a step of detecting an AE signal by a pair of first AE sensors attached to the first stationary part and the second stationary part, respectively; and
a step of determining, when rubbing occurs on the rotating machine, whether an occurrence position of the rubbing is a first unit including the first stationary part or a second unit including the second stationary part, based on the AE signal.
